(19) United States
(12) Patent Application Publication
(10) Pub. No.: US 2017/0237125 A1
(43) Pub. Date: Aug. 17, 2017

(54) Method for Producing a Prismatic Battery Cell

(71) Applicant: Robert Bosch GmbH, Stuttgart (DE)

(72) Inventors: Antonio Bacher, Tokyo (JP); Seyed Mohammad Seyed Abbassi, Pforzheim (DE); Cihan Kaplan, Osaka (JP); Michael Riefler, Reutlingen (DE)

(73) Assignee: Robert Bosch GmbH, Stuttgart (DE)

(21) Appl. No.: 15/328,165

(22) PCT Filed: Jul. 23, 2015
(86) PCT No.: PCT/EP2015/066942

§ 371 Date: Jan. 23, 2017

(30) Foreign Application Priority Data
Jul. 25, 2014 (DE) 102014214716.6

(51) Int. Cl. H01M 10/0587; H01M 10/0525; H01M 2/26

(52) U.S. Cl. CPC H01M 10/0587; H01M 2/263; H01M 10/0525; H01M 2220/20

(57) ABSTRACT

A method is used to produce a prismatic battery cell having a cathode layer, an anode layer and two separator layers. The method includes winding an initial arrangement including the cathode layer, the anode layer and the two separator layers around a winding axis to produce a battery winding. The cathode layer and the anode layer each have longitudinal sides and transverse sides and are wound with the transverse sides parallel to the winding axis. The method further includes inserting the battery winding in a cell housing. The method further includes contacting contact surfaces of the cathode layer and the anode layer with current collectors, filling the cell housing with a liquid electrolyte, and closing the cell housing. The cathode layer and the anode layer, on one of their longitudinal sides, are cut to size during their supply to the initial arrangement to form contact surfaces.

### PRIOR ART

The invention relates to a method for producing a prismatic battery cell, wherein the battery cell has a cathode layer, an anode layer and at least two separator layers.

The invention also relates to a prismatic battery cell which is produced in accordance with the method, and to a vehicle in which such a prismatic battery cell is installed.

Lithium ion accumulators which are used in the automobile sector often have a prismatic shape for volume utilization reasons. In the interior of a cell housing, for example, there are flat-pressed battery windings (jelly rolls), which are rolled from an anode, a cathode and from separator layers. The cell housing is filled with a liquid electrolyte following the insertion of the battery windings and before the pressure-tight closure. U.S. Pat. No. 8,641,015 B2 provides, for example, such a prismatic battery cell with four battery windings arranged therein.

Making electrical contact with the electrodes, by which the cathode and the anode are designated within the context of the present disclosure, is carried out in the following way, for example: the two electrodes are laid over each other, not with an accurate fit but slightly offset in the direction of the winding axis. This method is described, for example, in DE 10 2012 213 420 A1. Thus, the negative voltage can be tapped off from the respective electrode on an open narrow side of the battery winding, and the positive voltage on the other, opposite, open narrow side. Making contact with the projecting film strips is carried out with welded, strip-like sheet metal parts made of copper or aluminum, the so-called current collectors. This making of contact with the current collectors in the interior of the cell housing and leading the current paths through the cell housing to the outside is very demanding. Following the insertion of the battery windings into the cell housing and following the closure of the cell housing, the latter is filled with electrolyte through a small opening in the cover of the cell housing. As one of the last processes during the production of the battery cell, this opening is closed with a closure element.

Further examples of jelly rolls are known from U.S. Pat. No. 5,552,239 and JP 2009-266737.

US 2012/0189888 discloses a lithium ion battery cell in which a cathode layer and an anode layer with a separator positioned between the same are wound up spirally.

### DISCLOSURE OF THE INVENTION

### Advantages of the Invention

The method according to the invention for producing a prismatic battery cell, wherein the prismatic battery cell has a cathode layer, an anode layer and two separator layers, comprises the following steps:
a) winding a starting arrangement comprising the cathode layer, the anode layer and the two separator layers around a winding axis to produce a battery winding, wherein the cathode layer and the anode layer each have longitudinal sides and transverse sides and are wound with the transverse sides parallel to the winding axis,
b) inserting the battery winding into a cell housing,
c) making contact between contact surfaces of the cathode layer and the anode layer using current collectors,
d) filling the cell housing with a liquid electrolyte, and
e) closing the cell housing.

According to the invention, provision is made for the cathode layer and the anode layer to be cut to size on respectively one of their longitudinal sides in order to form the contact surfaces during the supply to the starting arrangement.

One advantage of the invention is that an uncoated long electrode edge is no longer needed. Advantageously, only the contact surfaces remain free of active material. This leads to more capacity, a higher energy density and to saving of material costs.

The chronological sequence of the steps during which the battery winding is inserted into a cell housing, contact is made with the cathode layer and the anode layer using current collectors, and the cell housing is filled with a liquid electrolyte, is in principle arbitrary.

According to an advantageous embodiment, exactly one battery winding is inserted into the cell housing, the battery winding having exactly one cathode layer and exactly one anode layer. This leads to lower costs when welding, since only a single battery winding has to be welded onto a current collector. In particular, this leads to material saving in the current collectors, since the latter no longer have to be brought up to multiple battery windings by means of branches. Advantages can also be seen in the fabrication process, since further operations are dispensed with when few individual parts are present. Thus, it is possible to use a single, unbranched current collector per electrode. The contour of the current collectors can be changed, which means that these are likewise simpler to produce. The cathode layer and the anode layer can be designated as cathode and anode, respectively, or jointly also as electrodes within the context of the present disclosure.

According to an advantageous embodiment, the longitudinal sides of the cathode layer and the anode layer, on which the contact surfaces are formed, are arranged one above another in the initial arrangement. Thus, the contact surfaces of the cathode layer and of the anode layer are located on the same side.

Preferably, the contact surfaces of the cathode layer and of the anode layer are in addition arranged offset relative to one another in the initial arrangement. By means of the physical separation of the contact surfaces, an electrical insulation of the cathode and of the anode can be ensured. Particularly preferable is a maximum offset of the opposite-pole contact surfaces relative to one another, each contact surface always being arranged exactly between two opposite-pole contact surfaces.

The cathode layer and the anode layer are preferably cut to size by means of a laser during the supply to the initial arrangement. One advantage in this case is the free choice in the way of shaping. Furthermore, the laser can be directly integrated into the winding machine. This results in a minimum reject rate. The offset of the individual contact tabs in the winding can therefore be precisely compensated for. As an alternative, provision can be made for continuous punching out to be carried out using a punching tool. The punching tool can be integrated in the winding machine in this case. As an alternative, punching out can be provided as an external process.

The contour of the electrodes is shaped by cutting the longitudinal sides of the electrodes to size. In the process, the contact surfaces produced out of the longitudinal sides of the cathode layer and of the anode layer are preferably projecting tabs, with which electrical contact is made with the current collectors. As the contact surfaces are cut to size, preferably only uncoated material of the cathode layer and of the anode layer is cut away.

According to a particularly advantageous embodiment, in step b) the battery winding is inserted into the cell housing in such a way that a filling opening and/or a burst diaphragm are located in alignment with the winding axis. If the filling opening is located in alignment with the winding axis, the battery winding needs less time to be fully saturated during filling with the liquid electrolyte. The flow direction of the liquid when filling through the filling opening is ideally located parallel to the winding axis. In addition, in the event of damage to the battery cell, a main direction of the dynamics that arise as a result is located parallel to the winding axis. This thus makes it easier for the liquid or gases to escape at the burst opening in the event of overpressure. “In alignment with the winding axis” designates the fact that the filling opening is located either on the winding axis or at a short distance from the latter.

Provision can be made for a winding blade additionally to be provided in the initial arrangement. In step a), winding takes place around the winding blade. The winding blade is formed, for example, as a flat plate with a rectangular cross section, having a first longer side and a second shorter side. The winding blade is made of plastic, for example, in particular from an electrolyte-resistant plastic that can be welded and/or adhesively bonded.

Provision is made that, in step a), the cathode layer and the anode layer and the two separator layers are initially fixed to the winding blade. The anode and cathode are welded to the winding blade at welding surfaces or adhesively bonded thereto. The separators are likewise fixed to the winding blade, for example adhesively bonded.

Provision can be made to remove the winding blade following the winding, which leads to an increase in the energy density of the battery winding. For the case in which the winding blade remains in the battery winding, the winding blade can also be designated as a winding core within the context of the invention.

According to a preferred embodiment, the winding axis is located parallel to a shorter side of the winding blade, so that the initial arrangement is wound around the shorter side of the winding blade. The cathode layer and the anode layer in this embodiment are fixed to the winding blade via surfaces which extend over the shorter side of the winding blade.

A further aspect provides a prismatic battery cell which has been produced in accordance with one of the methods described. The features described within the context of the methods likewise apply appropriately to the prismatic battery cell which has been produced in accordance with these methods.

According to the invention, a motor vehicle having a battery is additionally provided, wherein the battery has at least one such battery cell. The battery is preferably connected to a drive system of the motor vehicle. The motor vehicle can be equipped as a pure electric vehicle and comprise an exclusively electric drive system. Alternatively, the motor vehicle can be equipped as a hybrid vehicle, which comprises an electric drive system and an internal combustion engine. In some variants, provision can be made that the battery of the hybrid vehicle can be charged internally via a generator with excess energy from the internal combustion engine. Externally rechargeable hybrid vehicles (PHEV, plug-in hybrid electric vehicle) additionally provide the possibility of charging the battery via the external power network.

### BRIEF DESCRIPTION OF THE DRAWINGS

Exemplary embodiments of the invention are illustrated in the drawings and explained in more detail in the following description.

In the drawings

FIG. 1 shows a prismatic battery cell according to the prior art in a perspective view,

FIG. 2 shows a winding blade,

FIG. 3 shows an initial arrangement according to an embodiment of the invention,

FIGS. 4A, 4B show conventional and inventive electrode layers in plan view in comparison,

FIGS. 5A, 5B show a battery winding in sectional view and lateral plan view according to an embodiment of the invention, and

FIGS. 6A, 6B show conventional and inventive cover groups and battery windings in a lateral plan view in comparison.

In the following description of the exemplary embodiments of the invention, the same or similar components and elements are designated by the same or similar designations, a repeated description of these components or elements being dispensed with in individual cases. The figures illustrate the subject matter of the invention only schematically.

### Embodiments of the Invention

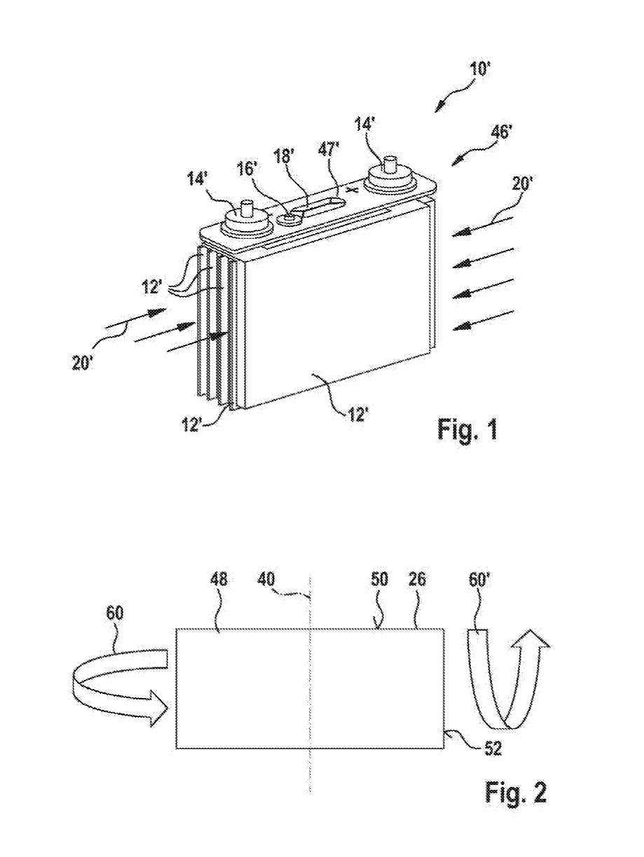

FIG. 1 shows a prismatic battery cell 10′ in a perspective view according to the prior art.

The prismatic battery cell 10′ is illustrated without a cell housing, for reasons of clarity, and comprises four battery windings 12′ arranged closely beside one another and a cover group 46′, the cover group 46′ comprising two terminals 14′, by which means electrical contact is made with the prismatic battery cell 10′ from outside.

The cover group 46′ is additionally assigned a filling opening 16′ and a burst diaphragm 18′. The filling opening 16′ and the burst diaphragm 18′ are located substantially in the center of a terminating plate 47′, whereas the terminals 14′ are placed peripherally on the terminating plate 47′. The battery windings 12′ are inserted into a cell housing and filled with the liquid electrolyte. An inward flow direction 20′ of a liquid electrolyte is indicated by arrows. The liquid electrolyte in FIG. 1 is put in vertically via the filling opening 16′ and then passes horizontally into the battery windings 12′, which are fully saturated with the liquid electrolyte. After that, the cell housing is closed with the cover group 46′.

FIG. 2 shows a winding blade 26. The winding blade 26 is formed from a plastic plate 48, for example. The plastic plate 48 has a rectangular outline with a longer side 50 and a shorter side 52. A conventional winding direction 60′ is around the longer side 50. A winding direction 60 around the shorter side 52 is proposed. The winding axis 40 is in this case arranged parallel to the shorter side 52.

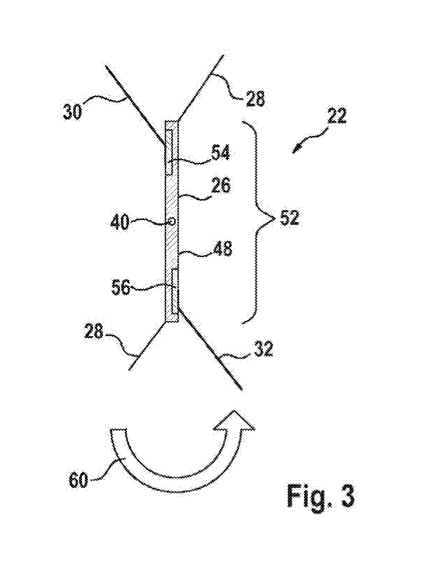

FIG. 3 shows an initial arrangement 22 with the winding blade 26, two separator layers 28, a cathode layer and an anode layer 32, wherein the winding blade 26 is configured as described with reference to FIG. 2. A sectional view along the winding axis from FIG. 2 is illustrated. The winding direction 60 of the initial arrangement 22 is illustrated by an arrow. The cathode layer 30 and the anode layer 32 are fixed to the winding blade 26 via welding surfaces 54, 56. The two separator layers 28 are adhesively bonded to the winding blade 26 opposite each other and insulate the cathode layer 30 from the anode layer 32.

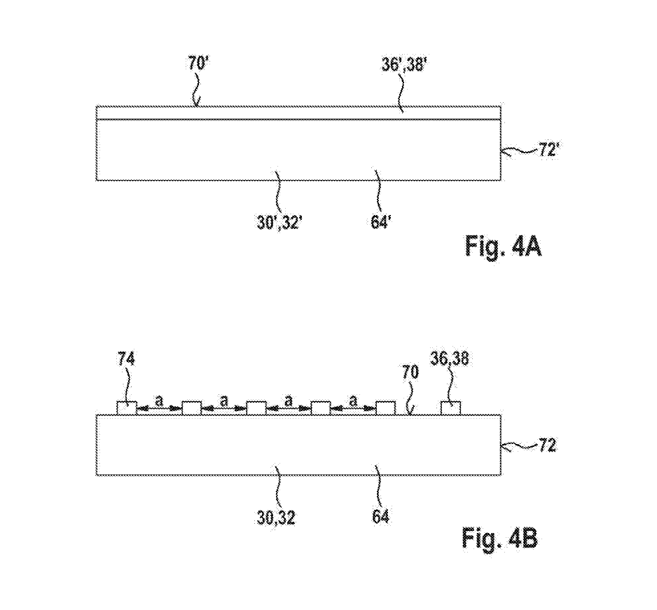

FIG. 4A shows a conventional electrode 30′, 32′, which has a contact surface 36′, 38′ which extends completely over a longitudinal side 70′ of the electrodes 30′, 32′, the longitudinal side 70′ being longer than a transverse side 72′.

An electrode 30, 32 according to the invention is illustrated in FIG. 4B, said electrode having contact surfaces 36, 38 formed as a small tab 74, which extends over a transverse side 72 of the electrode 30, 32. A surface 64′ of the conventional electrode 30′, 32′, which can be coated with active material, is as large as a surface 64 of the electrode 30, 32 according to the invention which can be coated with active material. Since the size of the contact surfaces 36, 38 is reduced with respect to the conventional electrodes, there is a lower specific volume in the electrode 30, 32 according to the invention, which increases the energy density of the prismatic battery cell 10 (not illustrated here).

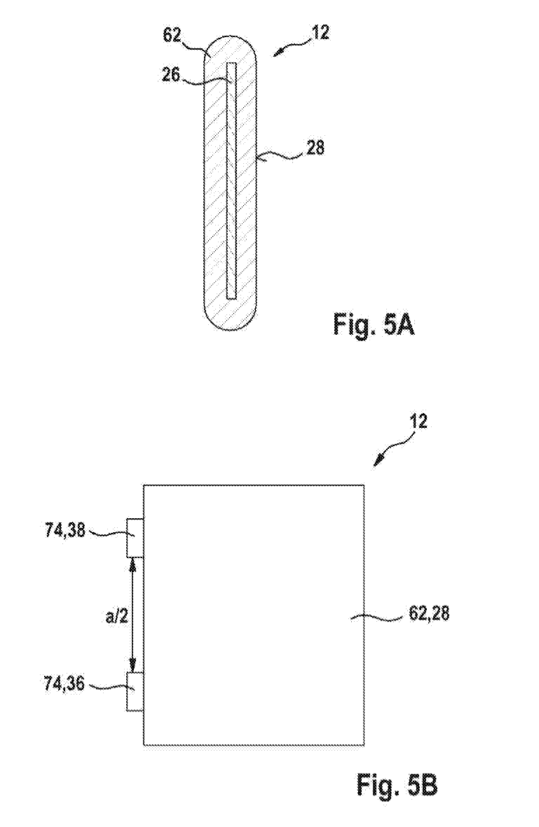

The cathode layer 30 and the anode layer 32 are supplied from endless strips to a winding device and cut to size in the form illustrated. The small tabs 74 are cut out of the strip with coated material by means of a laser. A distance a between the small tabs 74 is kept constant or increased slightly, in order to take account of the increase in winding radius during the winding. Because of the increasing radius of the jelly roll, the distances a of the individual small tabs 74 are adapted, in order to ensure an overlap of the small tabs 74 in the rolled state. In the winding direction, the small tabs 74 of the cathode layer 30 are offset at a maximum in relation to the small tabs of the anode layer 32 and are arranged over one another, in order to obtain the battery winding 12 in FIG. 5B.

It is possible for cutting with a laser to be carried out externally in the operation before the winding. However, the laser can also be installed directly in the winding machine in order to cut out the small tabs 74 in-line. The latter variant is to be preferred.

The winding does not necessarily have to be carried out around the winding blade 26. In some embodiments, the separator layers 28, cathode layer 30 and anode layer 32 are rolled up without a winding blade 26.

For the case in which a winding blade 26 was used during the winding, it can be removed after the winding process or remain in the battery winding 12. It is preferably removed in order to reduce the specific weight of the prismatic battery cell 10. In the case in which the winding blade 26 is removed, it is preferably made of metal with a clamping device. By holding the separator layers 28 firmly during the start of winding, it is then possible for winding to be carried out. After winding has been completed, the clamping device is opened and reduces the clamping width. Withdrawal is thus possible. Winding blades having this mechanism are known from the prior art.

FIG. 5A shows a sectional view of a battery winding 12 which is produced following winding of the starting arrangement 22 illustrated in FIG. 3. The winding blade 26 is located in the center of the battery winding 12. The wound layers 62 are located around the winding blade 26. The outermost of the wound layers 62 is a separator layer 28.

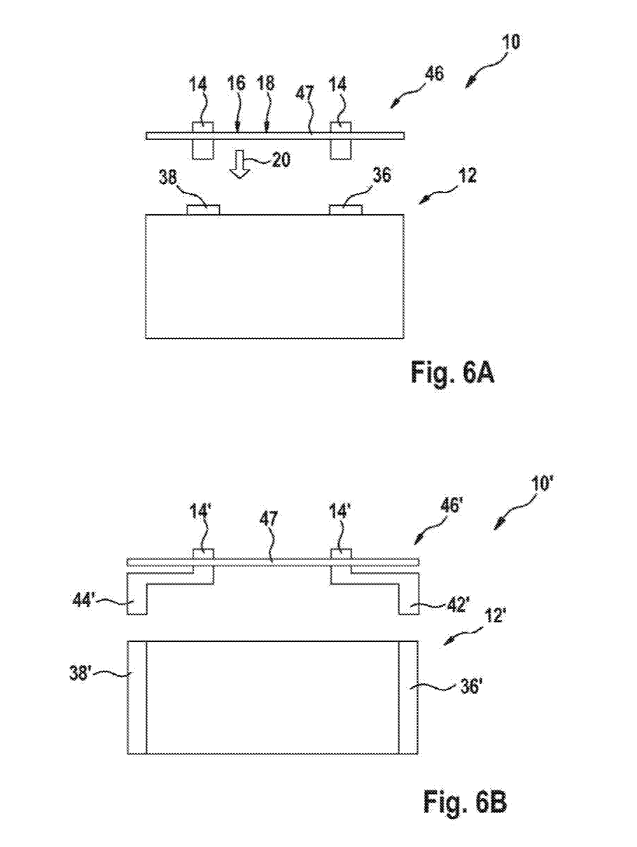

FIG. 5B shows a lateral plan view of the battery winding 12 which is produced following winding of the starting arrangement 22 illustrated in FIG. 3. The arrangement illustrated in FIG. 5A is illustrated as rotated through 90°. The small tabs 74 of the contact surfaces 36, 38 project laterally out of the wound layers 62, so that contact can be made with a cover group 46 as illustrated in FIG. 6A, the contact surfaces 36, 38 being welded to corresponding current collectors 42, 44. The small tabs 74 of the cathode layer 30 and of the anode layer 32 are arranged at a distance a/2.

FIG. 6A shows a prismatic battery cell 10 having a cover group 46 according to the invention and the battery winding 12 in an exploded illustration. The cover group 46 has the terminating plate 47 with the filling opening 16, the burst diaphragm 18 and terminals 14 arranged thereon, as well as the first current collector 42 of the cathode and the second current collector 44 of the anode.

The battery winding 12 can be inserted into the cell housing (not illustrated) in such a way that the inward flow direction 20 of the liquid electrolyte is located parallel to the filling opening 16 and to the burst diaphragm 18.

In addition, in the housing of the prismatic battery cell 10 there is advantageously arranged only a single battery winding 12, which signifies an increase in the energy density.

FIG. 6A and FIG. 6B additionally show the shortening of the path for making contact between the battery winding 12 and the terminals 14 of the cover group 46, which results when the embodiment according to the invention (FIG. 6A) is used, as compared with the prior art (FIG. 6B).

In the embodiment according to the invention, the current collectors 42, 44 are formed short and straight, since the terminals 14 are located opposite the contact surfaces 36, 38.

In the prior art, the contact surfaces 36′, 38′ are not arranged opposite the terminals 14′ but at the sides of the battery winding 12′, so that the current collectors 42′, 44′ are correspondingly longer and in addition have to be shaped.

The invention is not restricted to the exemplary embodiments described here and the aspects emphasized therein. Instead, within the area specified by the claims, a multiplicity of modifications which lie within the scope of professional activity are possible.

1. A method for producing a prismatic battery cell, wherein the prismatic battery cell has a cathode layer, an anode layer and at least two separator layers, comprising:
winding an initial arrangement comprising the cathode layer, the anode layer and the two separator layers around a winding axis to produce a battery winding, wherein the cathode layer and the anode layer each have longitudinal sides and transverse sides and are wound with the transverse sides parallel to the winding axis;
inserting the battery winding into a cell housing;
making contact between contact surfaces of the cathode layer and the anode layer using current collectors;
filling the cell housing with a liquid electrolyte; and
closing the cell housing,
wherein each of the cathode layer and the anode layer is cut to size on one of their longitudinal sides to form the contact surfaces during supply to the initial arrangement.

2. The method as claimed in claim 1, wherein the longitudinal sides of the cathode layer and the anode layer, on which the contact surfaces are formed, are arranged one above another in the initial arrangement.

3. The method as claimed in claim 1, wherein the contact surfaces of the cathode layer and of the anode layer are arranged offset relative to one another in the initial arrangement.

4. The method as claimed in claim 1, wherein the cathode layer and the anode layer are cut to size by a laser during the supply to the initial arrangement.

5. The method as claimed in claim 1, wherein the contact surfaces are tabs projecting out of the longitudinal sides of the cathode layer and the anode layer.

6. The method as claimed in claim 1, wherein as the contact surfaces are cut to size, only uncoated material of the cathode layer and of the anode layer is cut away.

7. The method as claimed in claim 1, wherein inserting the battery winding into a cell housing further includes inserting the battery winding into the cell housing such that a filling opening and/or a burst diaphragm are located in alignment with the winding axis.

8. The method as claimed in claim 1, wherein:
the initial arrangement has a winding blade;
winding the initial arrangement takes place around the winding blade; and
the winding blade is removed after the winding.

9. A prismatic battery cell, comprising:
a cathode layer;
an anode layer;
two separator layers;
a liquid electrolyte; and
a battery housing, wherein:
each of the cathode layer and the anode layer has longitudinal sides and transverse sides,
the cathode layer, the anode layer, and the separator layers are wound around a winding axis, the cathode layer and the anode layer wound with the transverse sides parallel to the winding axis, to form a battery winding,
the battery winding is inserted into the cell housing and the cell housing is filled with the liquid electrolyte,
each of the cathode layer and the anode layer includes a contact surface configured such that contact is made between the contact surfaces using current collectors,
the cell housing is closed, and
each of the cathode layer and the anode layer is cut to size on one of the longitudinal sides to form the contact surfaces.

10. A motor vehicle, comprising:
a battery which has at least one prismatic battery cell, the at least one prismatic battery cell including:
a cathode layer;
an anode layer;
two separator layers;
a liquid electrolyte; and
a battery housing, wherein:
each of the cathode layer and the anode layer has longitudinal sides and transverse sides,
the cathode layer, the anode layer, and the separator layers are wound around a winding axis, the cathode layer and the anode layer wound with the transverse sides parallel to the winding axis, to form a battery winding,
the battery winding is inserted into the cell housing and the cell housing is filled with the liquid electrolyte,
each of the cathode layer and the anode layer includes a contact surface configured such that contact is made between the contact surfaces using current collectors,
the cell housing is closed, and
each of the cathode layer and the anode layer is cut to size on one of the longitudinal sides to form the contact surfaces.
